(19) United States
(12) Patent Application Publication
(10) Pub. No.: US 2006/0073299 A1
(43) Pub. Date: Apr. 6, 2006

(54) Method for forming a metallic appearance on the sides of memo pads

(76) Inventor: Edward Killey, Syracuse, NY (US)

Correspondence Address: BOND, SCHOENECK & KING, PLLC, ONE LINCOLN CENTER, SYRACUSE, NY, 13202-1355, US

(21) Appl. No.: 11/243,091

(22) Filed: Oct. 4, 2005

Related U.S. Application Data
(60) Provisional application No. 60/615,773, filed on Oct. 4, 2004.

(51) Int. Cl. B32B 33/00

(52) U.S. Cl. 428/40.1

(57) ABSTRACT

A method is provided for forming a metallic appearance on the side of a memo pad by making the side of the memo pad smooth enough to accept a heat-transferred foil resulting in a mirror-like metallic finish. The cut side of the memo pad is polished to remove blade marks and any loose fibrous material. A thin layer of polymer is applied to the cut side and polished with a rotating metal roller. The polymer fills voids between cut fibers and the roller reduces high spots to a common plane. The resulting surface accepts a heat-transferred foil without showing individual sheet layers or cutting marks from the guillotine process and does not bond the adjacent edges of the sheets in the stack. Also disclosed is a memo pad having a metallic appearance on at least one side.

### CROSS-REFERENCE TO RELATED APPLICATION

The present application claims priority to U.S. Provisional Application Ser. No. 60/615,773, filed Oct. 4, 2004, the entirety of which is hereby incorporated by reference.

### FIELD OF THE INVENTION

The present invention relates to composite materials adapted by means of a smoothing process to enhance the appearance after being printed with metallic, prismatic or colored foils.

### BACKGROUND OF THE INVENTION

Pads of paper are commonly used for drawing, sketching and written communication. Enhancements have been made to pads to personalize them to the user, for advertising or to increase their aesthetic value by decorating them. Pads may be printed on the face and back of sheet to display information or to provide artistic decoration. The sides or edges of pads may also be used as printable surfaces. Typically, pads are formed in rectangular or square shapes. The straight edges or sides provide a surface capable of receiving printing or coloring to help differentiate and decorate the finished pad.

Foils may be applied to surfaces to provide an enhanced appearance in the form of a metallic, prismatic or colored effect. Gold foils have been used for many years to ‘gild’ the edges of books to provide a more sophisticated and desirable appearance. Modem foils of the hot-stamping variety provide a greater choice in metallic colorations such as silver, gold, copper, pewter, etc., without the cost associated with using real gold foil. These hot stamp foils also are currently produced with a wide range of prismatic or holographic patterns or renderings. Prismatic and holographic patterns are highly desirable as decorating mediums because of the brightness, color-changing and eye-catching reflections of the micro-embossed gratings used to create a prismatic or holographic image.

When using metallic or holographic foils, it is necessary to have a very smooth receiving surface to take advantage of the reflective qualities of metallized materials. As supplied, the foils are almost mirror-like in their reflective qualities. The smoother the receiving surface, the more mirror-like the appearance of the finished product. For prismatics and holographics, a smoother surface yields a brighter and better resolved image, enhancing the fine structure of detail required to generate a prismatic appearance.

Typically, the common edges of a stack of sheeted paper are cut with a guillotine blade to produce a smooth finish. This finish is sufficiently smooth for purposes of printing the sides of a memo pad, but is not sufficiently smooth for satisfactory application of foils. Extremely sharp guillotine blades last for a short time in production as the paper fibers and the earth fillers used in papermaking cause dulling, scoring and nicking of the honed blade edge. Even a freshly sharpened blade will create a cut surface that is not sufficiently smooth for aesthetically pleasing application of foils. While it is possible to apply foils to a guillotine-cut surface, the appearance is not aesthetically pleasing and does not achieve the desired mirror-like finish.

In addition, application of foil materials to the edges of cut pads requires careful control of the pressure of application. As applied to a traditionally cut pad edge, the foils, being extremely thin in nature are pressed with pressure and heat to fuse to the receiving surface. Insufficient pressure results in partial transfer of the foil and excessive pressure leaves a distorted or strained appearance in the metallic finish. A porous surface such as a normally prepared paper pad edge requires excessive force to adhere the thin foil layer because it is an uneven surface. The result is a dull metal finish reflecting the unevenness and/or dust of the underlying receiving surface.

In development of this invention, standard foils were obtained from API Foils, Lawrence, Kans. These foils were formulated for adhesion to paper surfaces. The foils ranged from colored metals to prismatic effects. Initial tests that applied the foils to unprepared sides of paper pads showed good adhesion between the foil and the pad sides, after adjusting the hot-stamping machine parameters. The best transfers nonetheless showed indications of knife-scoring, roughness and debris, which dulled the overall appearance of a solid gold foil. Prismatic foils were also duller in resolution compared to the original foil. When transferred to extremely smooth pad sides prepared according to the present invention, the foils were noticeably brighter and reflective and resembled the original un-stamped foil. Because of these observations, it was apparent that the sides of the paper pads require preparation as disclosed in the present invention to exploit the decorative value of the foils.

What is needed is a method of forming a metallic appearance on the sides of memo pads that produces a highly mirrored finish.

What is also needed is a method of preparing the sides of a paper pad to receive foil material such that the foiled sides present an attractive appearance.

Further, what is need is a paper pad having one or more sides that have been smoothed to receive a foil material and which present an attractive appearance upon application of the foil material.

### SUMMARY OF THE INVENTION

According to the present invention, a stack of paper sheets is cut by means of a guillotine blade to render all four edges of the stack smooth and to align each sheet with adjacent sheets. The cut edges appear smooth to the unaided eye but close examination shows fine grooves traversing the edge face. These grooves are an artifact from the profile of the blade edge. Usually visible are loose paper fibers torn and hanging from the paper fiber matrix which comprises a sheet of paper.

The stack of sheets is held together by applying a thin layer of acrylic or vinyl polymer across one face of the cut edges. Upon drying, this polymer holds all of the sheets in the stack together across one common face or side. Another method of securing all the sheets to remain in a uniform stack is the application of low tack adhesive, preferably a repositionable type known in the industry as microsphere dispersion. This adhesive is applied in a stripe along a portion of one surface of a paper sheet. Similarly adhesive-coated sheets are stacked upon each other to form a pad of paper with no outward signs of bonding. Such a stack of paper sheets may also be guillotined through the edges to form smooth, even sides.

After trimming the sides of the stack, the sides are smoothed to prepare them for receiving a foil via the hot-stamping method. The pad is compressed so that individual sheets are tightly pressed together. A thin layer of polymer is applied to the compressed edges and is subjected to heat and pressure to transfer the polymer to the edges of the paper sheets. The polymer infused edges are then burnished to a smooth surface and a foil layer is applied.

### BRIEF DESCRIPTION OF THE DRAWINGS

The present invention will be more fully understood and appreciated by reading the following Detailed Description in conjunction with the accompanying drawings, in which:

FIG. 1 is perspective, partial exploded view of a memo pad.

FIG. 2 is a sequential side view of a memo pad being prepared according to an embodiment of the present invention.

FIG. 3 is a flow chart of steps of a method of forming a metallic appearance on the sides of memo pads according to an embodiment of the present invention.

### DETAILED DESCRIPTION

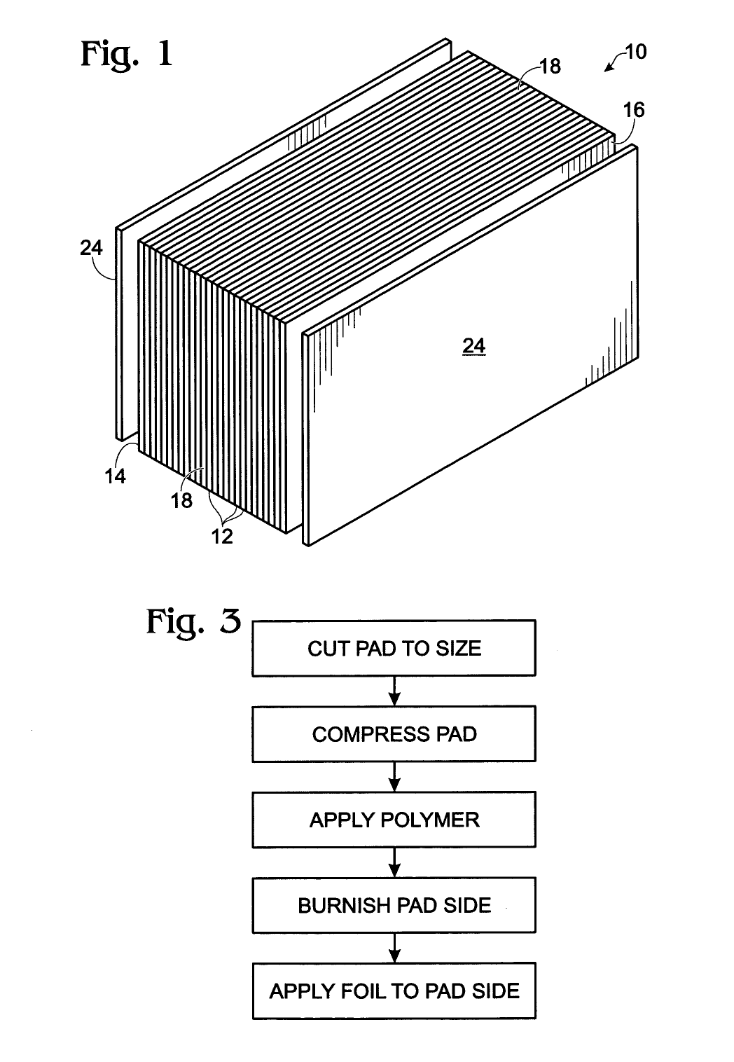

Referring now to FIG. 1, there is a memo pad 10 comprising a plurality of sheets of paper 12. Memo pad 10 includes top 14, bottom 16 and sides 18. As is known in the art, individual sheets 12 may be held together by application of an adhesive material (not shown) to one side 18 of pad 10, or by application of repositionable adhesive (not shown) to a portion of one surface of each sheet 12. As is also known in the art, memo pad 10 may be sized by cutting the edges of sheets 12.

According to the present invention, to facilitate a smoother side 18 that satisfactorily receives a foil layer, a polymer 20 such as polyvinyl alcohol (PVOH) is applied to a pad's 10 compressed side 18. Other polymers are also acceptable, provided they suitably bond to the foil material 30 as described below and are compatible with the paper fibers of the sheets 12. Preferably, polymer 20 is applied in a thin layer, using heat and pressure to transfer the polymer 20 into the sheet edges that comprise the side 18 surface.

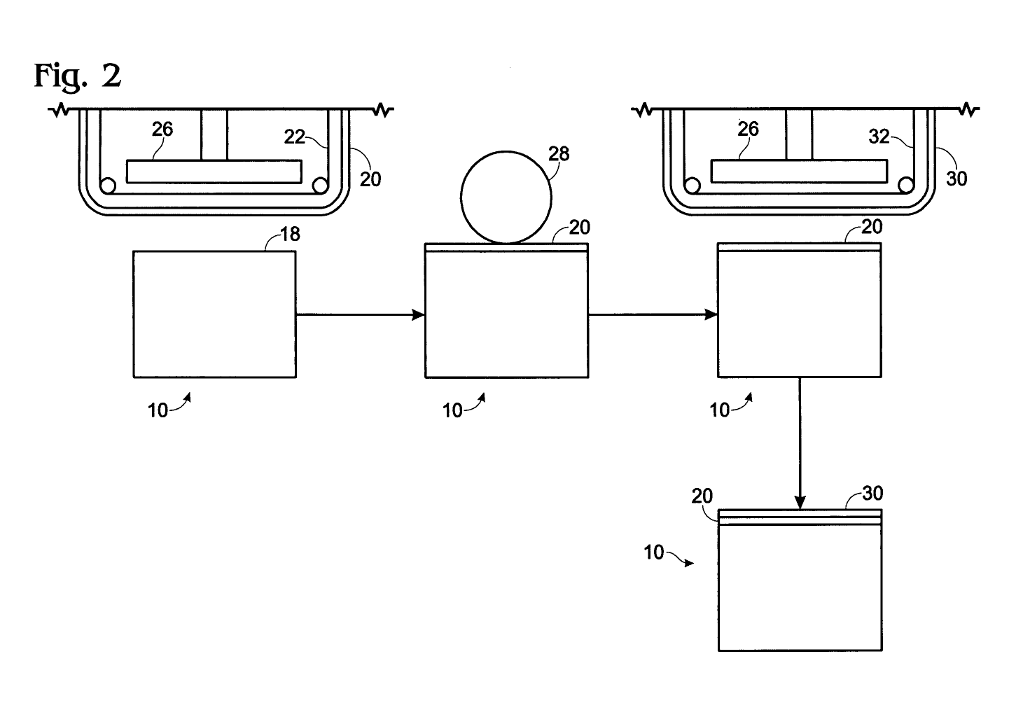

Referring now to FIG. 2, the polymer 20 is applied to the pad 10 side 18 by coating a thin layer of polymer 20 onto a polyester film 22 (FIG. 2). Preferably, polyester film 22 is approximately 50 microns in thickness and is in the form of a continuous web. After applying the polymer 20 to the polyester film 22, the polymer 20 is dried, leaving a coating that is preferably between 2 and 7 microns in thickness. The continuous polyester web 22 can be slit to a workable size for any given pad side 18. Ideally, the slit polyester film 22 is slightly wider than the area to which the polymer 20 is to be applied.

In preparation for application of the polymer 20, the pad 10 is held by opposing clamps 24 (FIG. 1) to compress the sheets 12 so they present a rigid and solid face comprised of a side 18 of the pad 10. Pressures of 30 to 80 psi have been found to provide adequate compression of sheets 12. Preferably, clamps 24 are positioned such that the side 18 that is to be coated with polymer 20 extends slightly beyond and parallel to the upper edges of clamps 24. This allows polyester film 22 with polymer coating 20 to contact the entire side 18 without interference or obstruction by clamps 24, while still maintaining suitable compression of the sheets 12. According to the preferred embodiment of the present invention, side 18 that is to be coated with polymer 20 extends beyond the upper edges of clamps 24 by approximately 3-5 mm. The coated film 22 is brought into contact with the pad 10 side 18. A flat, heated platen 26 is applied to heat and compress the coated film 22 into contact with the sheet 12 edges that comprise the side 18. Pressure on the platen 26 is adjusted to cause complete transfer of the polymer 20 layer onto the sheet 12 edges. After removing the polyester carrier 22, a smooth and glossy surface remains.

The sides 18 containing the polymer 20 layer are then burnished by a smooth metal roller 28 to increase the depth of the polymer 20 penetration and further smooth the surface of side 18. This burnishing step also helps the polymer 20 layer to bridge any larger score marks across the side 18 that were created by the guillotine knife. Without this burnishing step, the polymer 20 layer can create a bond between the edges of adjacent paper sheets 12. This is undesirable as the sheets 12 are expected by the user to be removed singly without any attachment to another sheet 12 except at the point where they were edge-glued or adhesive-stripe coated. The burnishing step also helps to incorporate the dust and loose fiber particles into the polymer 20 and paper fiber matrix. This burnishing step is preferably achieved through use of a metal roller 28 rotating at a high speed to produce a uniformly glossy surface with little, if any, edge attachment between adjacent sheet 12 edges. Rollers of various diameters are suitable, provided they have a smooth and/or polished surface. The speed of rotation of the roller should be selected to minimize the amount of heat generated during the burnishing step. Preferably the amount of heat generated during the burnishing step should not be sufficient to re-melt the polymer 20. According to the preferred embodiment, during the burnishing step pad 10 moves horizontally at a rate of 5-10 feet per minute, in a direction opposite the direction of rotation of roller 28.

Following the polymer 20 application and burnishing steps, the sides 18 of the pad 10 are ready to receive a foil layer 30. Because of the polymer 20 application and burnishing, the resulting foiled surface has a finish that maximizes the original luster and reflectivity of the original foil. The smooth surface of the pad sides 18 also enhances other pad side 18 decorating methods such as silk-screening of images, pre-printed color transfers or ink-jet imaging. The sides 18 of a finished, decorated paper pad, appear to be made of a continuous, solid surface.

Hot-stamping foils are commonly used in the printing and converting industry to add decorative metal accents where printing inks cannot provide a pure metal leaf appearance. The foils are produced using a thin polyester film, nominally 12 microns in thickness to transport the various coatings and metallization that comprise the finished foil. Typically a thin layer of releasable material is applied to the surface of the film. This material can be a wax or silicone-bearing polymer to provide the release of subsequent layers of coatings during the stamping process. Over this coating, a thin clear lacquer is applied. This lacquer dries to a glass-like surface and is the receiving layer for a metallization layer, usually aluminum. After vapor-deposition of the metallized layer, the construction now has a bright, shiny, reflective appearance, similar to a mirror. A final coating is applied over the metallization layer to act as a heat-bondable layer designed to adhere after heating and compression to the intended receiving surface.

According to the present invention, a pad 10 with a metallic appearance on its sides 18 is formed by applying foil material 30 to one or more sides 18 of a pad 10. As described above, foil material 30 is coated on polyester film 32. To apply the foil material 30 to a side 18, heat and pressure are applied to the foil material 30 and polyester film 32. Heat and pressure can be applied using flat, heated platens or heated rollers, as is known in the art. During heat and compression, the bondable layer of the foil material 30 softens and flows onto the side 18. After heat and compression are removed, the polyester film 32 is lifted away and all of the foil material 30 breaks cleanly from the film 32 to remain adhered to the side 18 of the pad 10.

In actual use, the bonding layer of a foil material 30 is formulated for the intended receiving surface. That is, different formulations of foil material 30 are made for application to paper, plastics or wood, etc. Additionally, the equipment used to stamp the foil 30 onto the object can be adjusted in at least three parameters to optimize the transfer and appearance of the finished foil marking: heat required to activate the bonding layer, pressure needed to force the softened bonding layer to conform across the receiving surface and dwell time—the amount of time needed to cause the foil 30 to soften and form a bond before removing the film carrier 32. Holographic foils are similar in construction except that the first lacquer layer is embossed to receive fine etching or diffraction gratings that produce the foil's light-scattering effect. Metallization over the embossing helps enhance the reflectivity and light-scattering needed for the holographic appearance.

The scope of the present invention should not be limited to the materials and methods described herein for many alternative but similar techniques and materials, obvious to those skilled in the art.

What is claimed is:

1. A method of forming a memo pad having a side with a metallic appearance, comprising the steps of:
compressing a pad comprised of a plurality of paper sheets, each said sheet having at least one edge, wherein the at least one edge of adjacent paper sheets form a generally planar surface;
applying a polymer to said generally planar surface to form a polymer coated surface;
burnishing said polymer coated surface; and
applying foil material to said polymer coated surface.

2. The method of claim 1, wherein the step of compressing a pad includes pressing said plurality of sheets together using pressure of at least 30 psi.

3. The method of claim 2, wherein the step of compressing a pad includes pressing said plurality of sheets together using pressure of no more than 80 psi.

4. The method of claim 1, further comprising the step of preparing a polymer coated web.

5. The method of claim 4, wherein the step of applying a polymer includes placing said polymer coated web in contact with said generally planar surface.

6. The method of claim 5, wherein the step of applying a polymer includes transferring said polymer from web material to said generally planar surface.

7. The method of claim 1, wherein the step of burnishing said polymer coated surface further comprises rotating a smooth-surface roller against said polymer coated surface.

8. The method of claim 1, wherein the step of applying foil material includes placing a foil coated web in contact with said polymer coated surface.

9. The method of claim 9, wherein the step of applying foil material includes applying heat and pressure to said foil coated web.

10. The method of claim 1, wherein the step of applying a polymer includes applying polyvinyl alcohol.

11. The method of claim 1, wherein the step of applying foil material to said polymer coated surface includes applying holographic foil material.

12. A memo pad having a side with a metallic appearance, comprising:
a plurality of paper sheets, each said sheet having at least one edge, wherein the at least one edge of adjacent sheets form a generally planar surface;
polymer coating said at least one edge of adjacent paper sheets; and
foil material adhered to said polymer.

13. The memo pad of claim 12 wherein said polymer is polyvinyl alcohol.

14. The memo pad of claim 12 wherein each of said plurality of paper sheets further comprises a first surface and a second surface, wherein repositionable adhesive is applied to at least a portion of said first surface.

15. The memo pad of claim 12 wherein said foil material comprises a pattern.
